(19) United States
(12) Patent Application Publication
(10) Pub. No.: US 2020/0363739 A1
(43) Pub. Date: Nov. 19, 2020

(54) ELECTROPHOTOGRAPHIC PHOTORECEPTOR, PROCESS FOR PRODUCING THE ELECTROPHOTOGRAPHIC PHOTORECEPTOR, AND ELECTROPHOTOGRAPHIC DEVICE

(71) Applicant: FUJI ELECTRIC CO., LTD., Kawasaki-shi (JP)

(72) Inventors: Masaru TAKEUCHI, Matsumoto-city (JP); Hirotaka KOBAYASHI, Matsumoto-city (JP); Fengqiang ZHU, Matsumoto-city (JP)

(73) Assignee: FUJI ELECTRIC CO., LTD., Kawasaki-shi (JP)

(21) Appl. No.: 16/984,071

(22) Filed: Aug. 3, 2020

Related U.S. Application Data
(63) Continuation of application No. PCT/JP2019/002462, filed on Jan. 25, 2019.

(51) Int. Cl. G03G 5/047; G03G 5/05; G03G 5/06; G03G 15/00

(52) U.S. Cl. CPC G03G 5/047; G03G 5/0564; G03G 15/75; G03G 5/0672; G03G 5/0696

(57) ABSTRACT

An electrophotographic photoreceptor having sufficient solvent resistance and crack resistance in a liquid developer and having excellent electrical characteristics, a process for producing the photoreceptor, and an electrophotographic device are provided at low cost. The electrophotographic photoreceptor includes a conductive base; and a charge generation layer and a charge transport layer sequentially provided on the conductive base. The charge transport layer contains a binder resin that is a copolycarbonate resin having a structure represented by general formula (1) below:

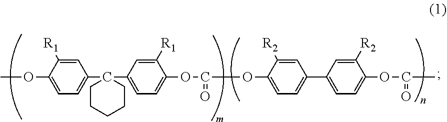

and a hole transport material that is a compound having a structure represented by general formula (2) below:

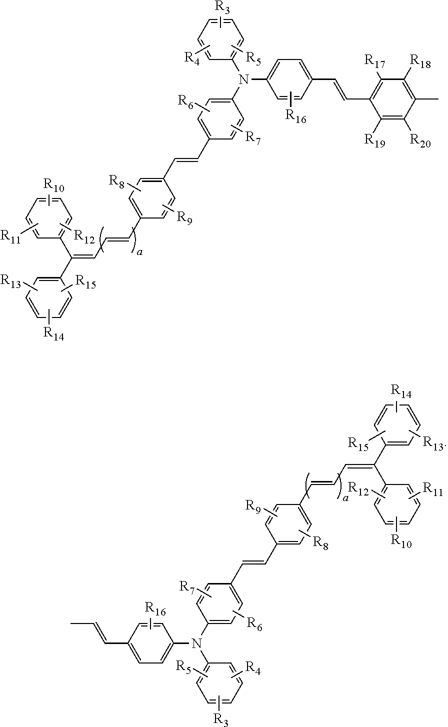

### CROSS-REFERENCE TO RELATED APPLICATION(S)

This non-provisional Application for a U.S. Patent is a Continuation of International Application PCT/JP2019/002462 filed Jan. 25, 2019, the entire contents of which is hereby incorporated by reference.

### BACKGROUND OF THE INVENTION

### 1. Field of the Invention

The present invention relates to an electrophotographic photoreceptor (hereinafter, simply referred to as “photoreceptor”) used in electrophotographic copiers, printers, or the like, a process for producing the photoreceptor, and an electrophotographic device, and more particularly, to a negatively charged layered type electrophotographic photoreceptor for liquid development having excellent solvent resistance and excellent electrical characteristics by containing a specific binder resin and a hole transport material in a charge transport layer, a process for producing the photoreceptor, and a liquid developing electrophotographic device.

### 2. Background of the Related Art

Development methods for visualizing an electrostatic latent image on a photoreceptor in electrophotographic processes are broadly classified into: dry developing using powder toner; and liquid developing using liquid developer in which toner is dispersed in an insulating liquid. For general office use, dry developing apparatuses are mainly used. On the other hand, since toner (particle size: from 0.1 to 2 μm) smaller in particle size than powder toner (particle size: from 5 to 8 μm) can be used in the liquid developing, and higher resolution can be achieved than in the dry developing, liquid developing apparatuses have advantages of being able to obtain a high image quality close to that of offset printing, and also being able to support higher printing speeds, and are thus being used for new commercial printing systems such as on-demand printing instead of offset printing.

On the other hand, inorganic photoreceptors using inorganic photoconductive materials such as selenium, a selenium alloy, zinc oxide, or cadmium sulfide which have been mainly used as photoreceptors that play a central role in an electrophotographic process, and recently, organic photoreceptors using organic photoconductive materials have been actively developed, taking advantage of the non-polluting properties, film-forming properties, and light weight thereof. Among others, a so-called function-separated layered organic photoreceptor including a photosensitive layer in which a charge generation layer and a charge transport layer, each having a separate function, are layered and has many advantages such as easy control of characteristics by forming each layer with a material suitable for each function and is mainly used as an organic photoreceptor. The charge generation layer mainly functions as a layer that generates electric charge when receiving light, and the charge transport layer mainly functions as a layer that holds a charged potential in a dark place and transports electric charge when receiving light.

When such organic photoreceptors are used in liquid developing, the solvent resistance of a photosensitive layer to an organic solvent contained in a liquid developer is important. Since a high insulating property is required for a solvent of a liquid developer, a hydrocarbon solvent such as isoparaffin is frequently used. When such a hydrocarbon solvent and a photoreceptor are in contact with each other for a long time, a charge transport material contained in a charge transport layer is eluted into a liquid developer, which may cause various problems. Specifically, elution of the charge transport material may cause a decrease in charge transport ability and sensitivity, and internal stress and swelling of a binder resin with a hydrocarbon solvent may cause a crack or the like, thereby lowering the durability.

In order to solve such problems, for example, Patent Document 1 proposes to prevent a charge transport agent from being eluted into a liquid developer by forming a surface protective layer made of a thermosetting resin on the surface of a photoreceptor. However, in such a photoreceptor, new problems arise such as a reduction in sensitivity and an increase in manufacturing cost due to the provision of a new surface protective layer.

Patent Document 2 proposes to improve crack resistance in a liquid development system by using a specific polyarylate resin for a photosensitive layer, and although a slight improvement was observed, crack resistance was not sufficient, and electrical characteristics were also inferior, and therefore, such a propose did not provide a sufficient practical performance.

Further, Patent Document 3 discloses to improve crack resistance and the like by setting a binder resin for a charge transport layer to a polycarbonate resin having an inorganic value/organic value (I/O value) of 0.37 or more, and particularly in the range of from 0.37 to 0.45, and setting the molecular weight of a hole transport agent to 900 or more, and particularly in the range of from 900 to 1,547.1. However, even with such a photoreceptor, an effect of preventing elution of a charge transport agent into a liquid developer was not sufficient, and it was difficult to say that the crack resistance was sufficient.

Still further, Patent Document 4 discloses a predetermined triphenylamine derivative, and a charge transport material and an electrophotographic photoreceptor using the same, and Patent Document 5 discloses an electrophotographic photoreceptor in which a specific binder resin, a hole transport material, an electron transport material, and an antioxidant are used for a charge transport layer and in which the mass ratio of the hole transport material in the charge transport layer is specified.

### RELATED ART DOCUMENTS—PATENT DOCUMENTS

Patent Document 1, JPH10-221875A;

Patent Document 2, JP2010-96811A;

Patent Document 3, JP2006-208880A;

Patent Document 4, WO2017/138566; and

Patent Document 5, WO2018/150693.

### PROBLEMS TO BE SOLVED BY THE INVENTION

The present invention has been made in view of the above, and an object of the present invention is to provide an electrophotographic photoreceptor that can be mounted on liquid developing apparatuses, has sufficient solvent resistance and crack resistance to hydrocarbon solvents, and has excellent electrical characteristics, a process for producing thereof, and an electrophotographic device, at a low cost.

### SUMMARY OF THE INVENTION

### Means for Solving the Problems

As a result of intensive studies to solve the above-mentioned problems, the present inventors have found that, by containing a specific binder resin and a hole transport material in a charge transport layer in an electrophotographic photoreceptor, solvent resistance and crack resistance can be improved while excellent sensitivity characteristics are maintained, thereby completing the present invention.

Specifically, a first aspect of the present invention provides an electrophotographic photoreceptor including: a conductive base; and a charge generation layer and a charge transport layer sequentially provided on the conductive base, wherein the charge transport layer contains a binder resin that is a copolycarbonate resin having a structure represented by general formula (1) below:

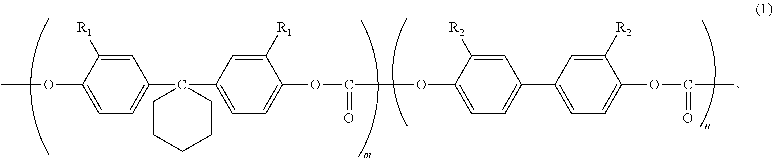

where R₁ and R₂ are the same or different and each represents a hydrogen atom, an alkyl group having from 1 to 10 carbon atoms or a fluoroalkyl group having from 1 to 10 carbon atoms, m and n are numbers satisfying 0.4≤n/(m+n)≤0.6, and a chain end group that is a monovalent aromatic group or a monovalent fluorine-containing aliphatic group; and a hole transport material that is a compound having a structure represented by general formula (2) below:

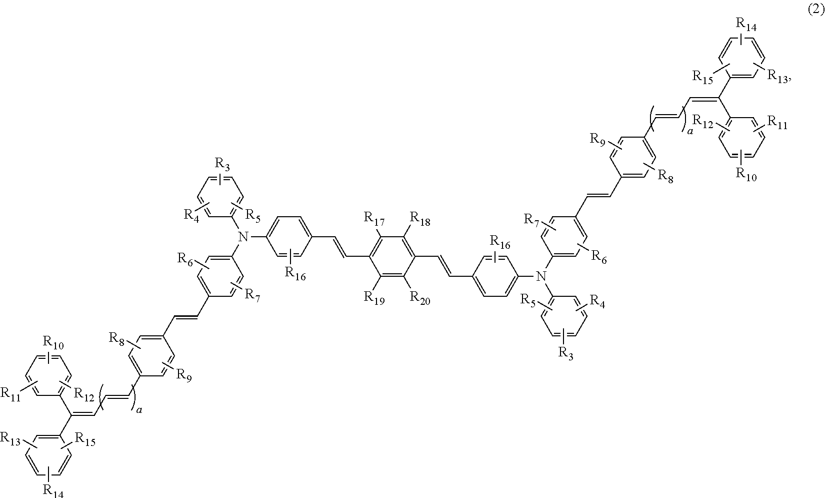

where R₃ to R₂₀ are the same or different and each represents a hydrogen atom, an alkyl group having from 1 to 6 carbon atoms, an alkoxy group having from 1 to 6 carbon atoms, an aryl group, or an aryl-substituted alkenyl group, and a represents an integer from 0 to 2.

Here, preferably, a mass ratio H/(B+H) indicating a ratio of mass (H) of the hole transport material to a sum of the mass (H) of the hole transport material and a mass (B) of the binder resin in the charge transport layer satisfies formula (3) below:

20% by mass≤H/(B+H)≤50% by mass (3).

Preferably, the charge transport layer has a thickness of 25 μm or less. Further, preferably, the charge generation layer contains a charge generation material that is Y-type titanyl phthalocyanine.

Still further, preferably, the electrophotographic photoreceptor has an initial sensitivity V_{L} (−V) that has an absolute value measured using an electrical characteristics test system for photoreceptors under conditions including an initial charged potential of −1,000 V, a travel time from exposure to a potential measurement probe of 0.03 s, an exposure light wavelength of 650 nm, and an exposure of 1.0 μJ/cm² that is 80 or less. Still further, preferably, in the electrophotographic photoreceptor, the hole transport material is eluted from the charge transport layer, when the electrophotographic photoreceptor is immersed in a hydrocarbon solvent contained in a developer for liquid development at room temperature for 100 hours, in an eluted amount that is 5×10⁻⁸ g/cm³ or less.

A second aspect of the present invention provides a process for producing the electrophotographic photoreceptor described above, the process including forming the charge generation layer and the charge transport layer by using a dip coating method.

Further, a third aspect of the present invention provides an electrophotographic device including: the electrophotographic photoreceptor described above; a charging device for charging the electrophotographic photoreceptor to provide a charged electrophotographic photoreceptor; an exposure apparatus for exposing the charged electrophotographic photoreceptor to form an electrostatic latent image on a surface thereof; a development device for forming a toner image by developing the electrostatic latent image formed on the surface of the electrophotographic photoreceptor using a liquid developer in which a toner is dispersed in a hydrocarbon solvent; and a transfer device for transferring the toner image formed on the surface of the electrophotographic photoreceptor to a recording medium.

### Effects of the Invention

According to the present invention, an electrophotographic photoreceptor that has excellent sensitivity characteristics, has a small amount of hole transport material eluted even when contacted with a hydrocarbon solvent used as a developer for liquid development, and has excellent solvent resistance and crack resistance, a process for producing the same, and an electrophotographic device can be provided by adopting the above configuration.

### BRIEF DESCRIPTION OF THE DRAWINGS

FIG. 1 is a schematic sectional view showing an example of an electrophotographic photoreceptor of the present invention; and

FIG. 2 is a schematic configuration diagram showing an example of an electrophotographic device of the present invention.

### DETAILED DESCRIPTION OF THE INVENTION

Hereinafter, embodiments of the electrophotographic photoreceptor of the present invention will be described in detail with reference to the drawings.

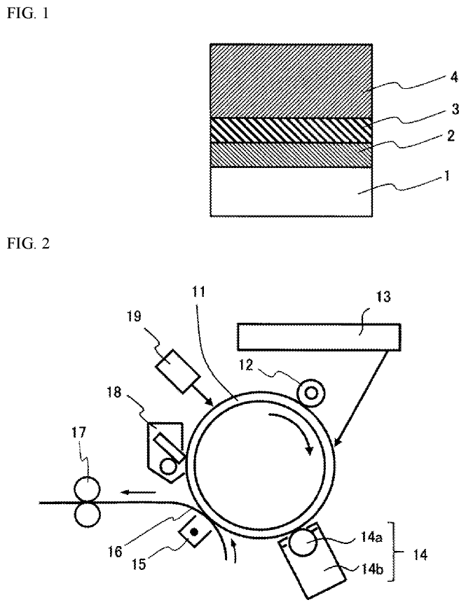

FIG. 1 is a schematic sectional view showing an example of an electrophotographic photoreceptor of the present invention. The illustrated photoreceptor is an electrophotographic photoreceptor including: a conductive base 1; and a charge generation layer 3 and a charge transport layer 4 sequentially provided on the conductive base 1. In the electrophotographic photoreceptor, the charge generation layer 3 and the charge transport layer 4 may be provided on the conductive base 1 via the intermediate layer 2. The intermediate layer is provided if necessary, and the charge generation layer 3 and the charge transport layer 4 may be provided directly on the conductive base 1. The electrophotographic photoreceptor may be a negatively charged layered type photoreceptor applied to a negatively charged process.

### Conductive Base

The conductive base 1 serves not only as an electrode of the photoreceptor but also as a support for the other layers, and may be cylindrical, plate-like, or film-like, and is usually cylindrical. The conductive base 1 to be used is made of a metal such as a known aluminum alloy such as JIS3003, JIS5000, or JIS6000, a stainless steel, or nickel, or a material obtained by performing a conductive treatment on glass, a resin, or the like.

The conductive base 1 can be finished into a base having a predetermined dimensional accuracy by extrusion or drawing when made of an aluminum alloy, or by injection molding when made of a resin material. The surface of the base can be processed to an appropriate surface roughness by cutting using a diamond tool, if necessary. The surface of the base can then be cleansed by degreasing and washing using an aqueous detergent such as a weak alkaline detergent.

The intermediate layer 2 can be provided on the surface of the conductive base 1 thus cleansed, if necessary.

### Intermediate Layer

The intermediate layer 2 is made of a layer mainly composed of a resin or an oxide film such as alumite and is provided if necessary for the purposes of preventing unwanted charges from being injected from the conductive base 1 into the charge generation layer 3, covering defects on the surface of the base, improving the adhesion of the charge generation layer, and the like.

As the resin material for forming the intermediate layer 2, a polycarbonate resin, a polyester resin, a polyvinyl acetal resin, a polyvinyl butyral resin, a polyvinyl alcohol resin, a vinyl chloride resin, a vinyl acetate resin, a polyethylene, a polypropylene, an acrylic resin, a polyurethane resin, an epoxy resin, a melamine resin, a silicone resin, a polyamide resin, a polystyrene resin, a polyacetal resin, a polyarylate resin, a polysulfone resin, a methacrylate polymer, and a copolymer thereof, and the like can be used singly or in an appropriate combination of two or more kinds thereof. Resins of the same kind having different molecular weights may be used as a mixture.

The above-described resin material may contain fine particles of a metal oxide such as silicon oxide, titanium oxide, zinc oxide, calcium oxide, aluminum oxide, or zirconium oxide, fine particles of a metal sulfate such as barium sulfate or calcium sulfate, fine particles of a metal nitride such as silicon nitride or aluminum nitride, an organometallic compound, a silane coupling agent, a material formed from an organometallic compound and a silane coupling agent, or the like. These contents can be set to any values as long as a layer can be formed.

In the case of the intermediate layer 2 containing a resin as a main component, a hole transport material or an electron transport material can be contained for the purpose of imparting charge transport properties and reducing charge traps. As such a hole transport material and an electron transport material, the same materials as those usable for the charge transport layer 4 described below can be used. The content of such a hole transport material and an electron transport material is preferably from 0.1 to 60% by mass, and more preferably from 5 to 40% by mass, based on the solid content of the intermediate layer 2. If necessary, other known additives may be contained in the intermediate layer 2 as long as the electrophotographic properties are not significantly impaired.

The intermediate layer 2 may be used as a single layer, or two or more different types of layers may be layered. Although the film thickness of the intermediate layer 2 also depends on the composition of the intermediate layer 2, the thickness can be set to any value within a range that does not cause an adverse effect such as an increase in residual potential when the layer is used repeatedly and continuously and is preferably from 0.1 to 10 μm.

### Charge Generation Layer

The charge generation layer 3 is provided on the conductive base 1 or the intermediate layer 2. The charge generation layer 3 is formed by, for example, applying a coating liquid in which particles of a charge generation material are dispersed in a binder resin, and receives light to generate charges. It is desirable that the charge generation layer 3 has high charge generation efficiency and easily injects charges into the charge transport layer 4.

The charge generation material is not particularly limited as long as the material has a photosensitivity at the wavelength of an exposure light source, and an organic pigment such as a phthalocyanine pigment, an azo pigment, a quinacridone pigment, an indigo pigment, a perylene pigment, a polycyclic quinone pigment, an anthantrone pigment, or a benzimidazole pigment can be used. The charge generation layer 3 preferably contains a Y-type titanyl phthalocyanine as a charge generation material. By using a Y-type titanyl phthalocyanine as a charge generation material in the charge generation layer 3, a more excellent electrophotographic photoreceptor for the sensitivity characteristics, electrical characteristics, stability and the like can be provided when a hole transport material and an electron transport material are used in combination.

The charge generation layer 3 can be formed by applying a coating liquid prepared by dispersing or dissolving the above-described charge generation material, for example, in a binder resin such as a polyester resin, a polyvinyl acetate resin, a polymethacrylate resin, a polycarbonate resin, a polyvinyl butyral resin, and a phenoxy resin onto the above-described conductive base 1 or the intermediate layer 2.

The content of the charge generation material in the charge generation layer 3 is preferably from 20 to 80% by mass, and more preferably from 30 to 70% by mass, based on the solid content in the charge generation layer 3. The content of the binder resin in the charge generation layer 3 is preferably from 20 to 80% by mass, and more preferably from 30 to 70% by mass, based on the solid content in the charge generation layer 3. The thickness of the charge generation layer 3 can be usually set to from 0.1 μm to 0.6 μm.

By providing the charge transport layer 4 on the above-described charge generation layer 3, a photoreceptor can be obtained.

### Charge Transport Layer

The charge transport layer 4 contains at least a copolycarbonate resin having a structure represented by the above-described general formula (1) as a binder resin and a compound having a structure represented by the above-described general formula (2) as a hole transport material. Since a copolycarbonate resin having a structure represented by the above-described general formula (1) has high toughness, by using the resin as a binder resin, an effect that, even when an internal stress is generated in the charge transport layer 4, a crack is unlikely to occur can be obtained. A compound having a structure represented by the above-described general formula (2) has a feature that the compound is hardly eluted even when immersed in a hydrocarbon solvent for a long time. Therefore, by using the above-described specific combination of a binder resin and a hole transport material used for the charge transport layer 4, even when the charge transport layer 4 is in contact with a hydrocarbon solvent used as a developer for liquid development for a long time, elution of the hole transport material from the charge transport layer 4 to the solvent can be suppressed. With such a composition of a charge transport layer, excellent solvent resistance and crack resistance can be obtained, and an electrophotographic photoreceptor excellent in sensitivity characteristics can be realized at low cost. It is no longer necessary to provide a surface protective layer in order to avoid contact between a charge transport layer and a solvent.

Specific examples of a copolycarbonate resin having a structure represented by the above-described general formula (1) as the binder resin constituting the charge transport layer 4 include the following but are not limited thereto.

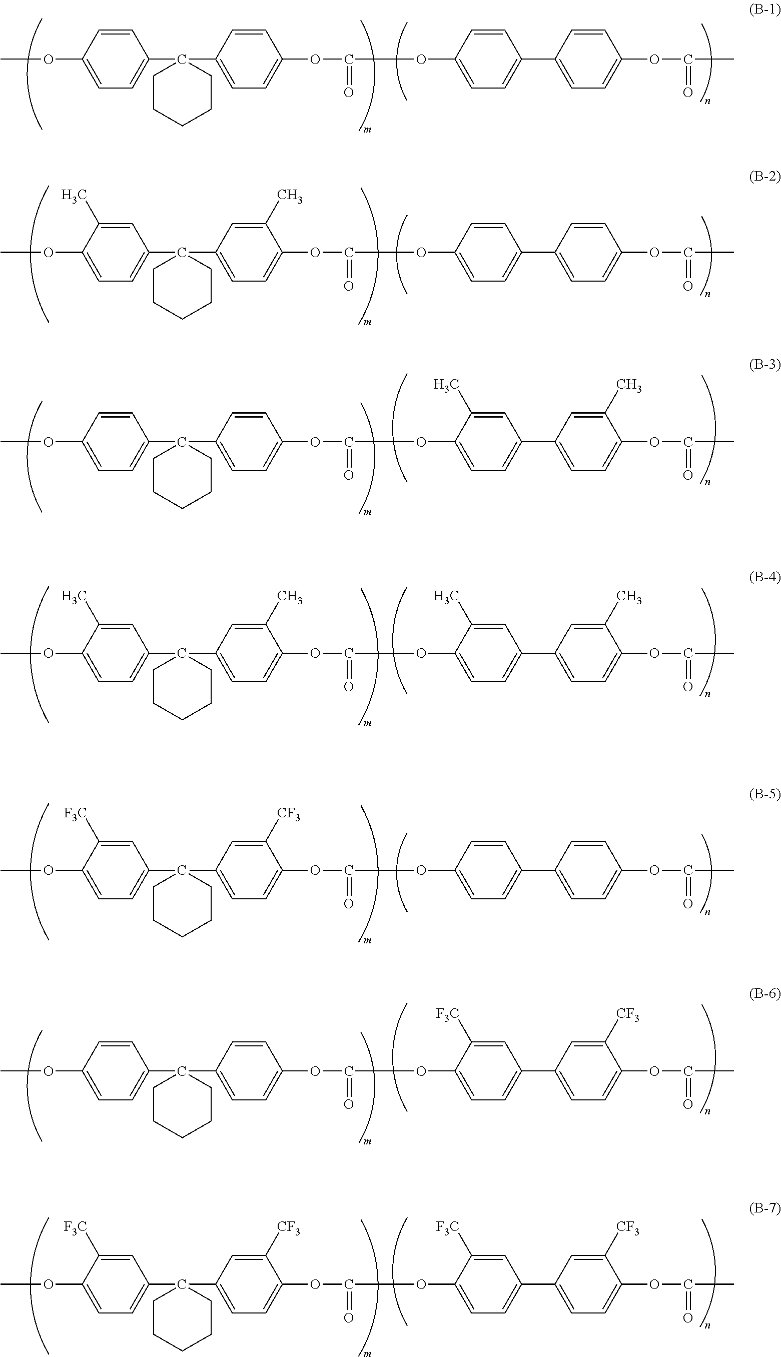

The ratio of m and n preferably satisfies 0.4≤n/(m+n)≤0.6, and the chain end group is preferably a monovalent aromatic group or a monovalent fluorine-containing aliphatic group.

It is necessary to use a copolycarbonate resin represented by the general formula (1) as a binder resin for the charge transport layer 4, and if necessary, another known resin can be used in combination within a range that does not significantly impair an effect of the present invention.

As the other resin that can be used as the binder resin of the charge transport layer 4, for example, a thermoplastic resin such as a polycarbonate resin other than a copolycarbonate resin represented by the general formula (1), a polyarylate resin, a polyester resin, a polyvinyl acetal resin, a polyvinyl butyral resin, a polyvinyl alcohol resin, a vinyl chloride resin, a vinyl acetate resin, a polyethylene resin, a polypropylene resin, a polystyrene resin, an acrylic resin, a polyamide resin, a ketone resin, a polyacetal resin, a polysulfone resin, and a methacrylate polymer or a thermosetting resin such as an alkyd resin, an epoxy resin, a silicone resin, a urea resin, a phenol resin, an unsaturated polyester resin, a polyurethane resin, or a melamine resin, a copolymer thereof, or the like can be used singly or in an appropriate combination of two or more kinds thereof. In the binder resin of the charge transport layer 4, the ratio of the inorganic value to the organic value (I/O value) may be less than 0.37.

Specific examples of the compound having a structure represented by the general formula (2) as the hole transport material constituting the charge transport layer 4 include the following but are not limited thereto.

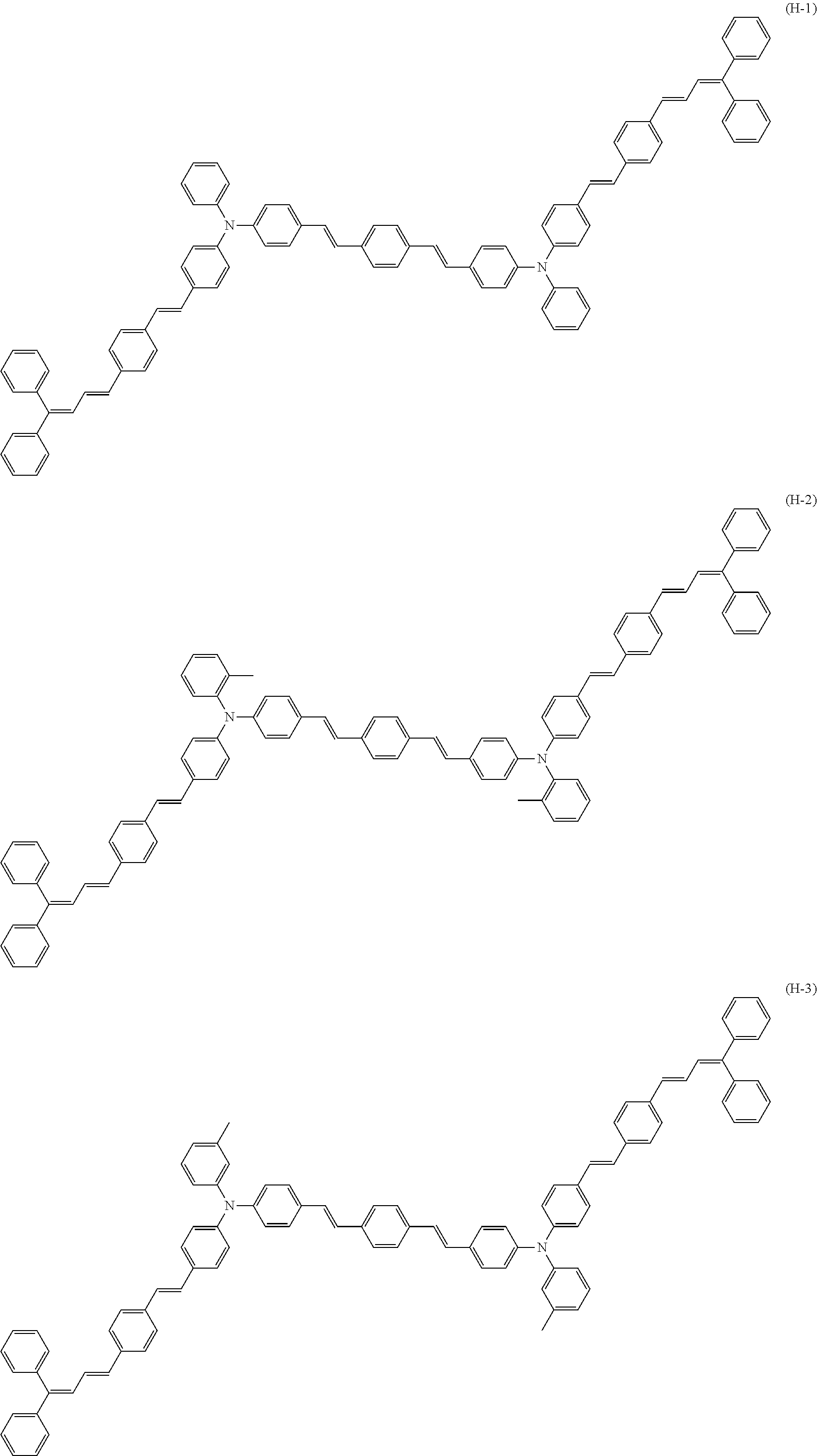

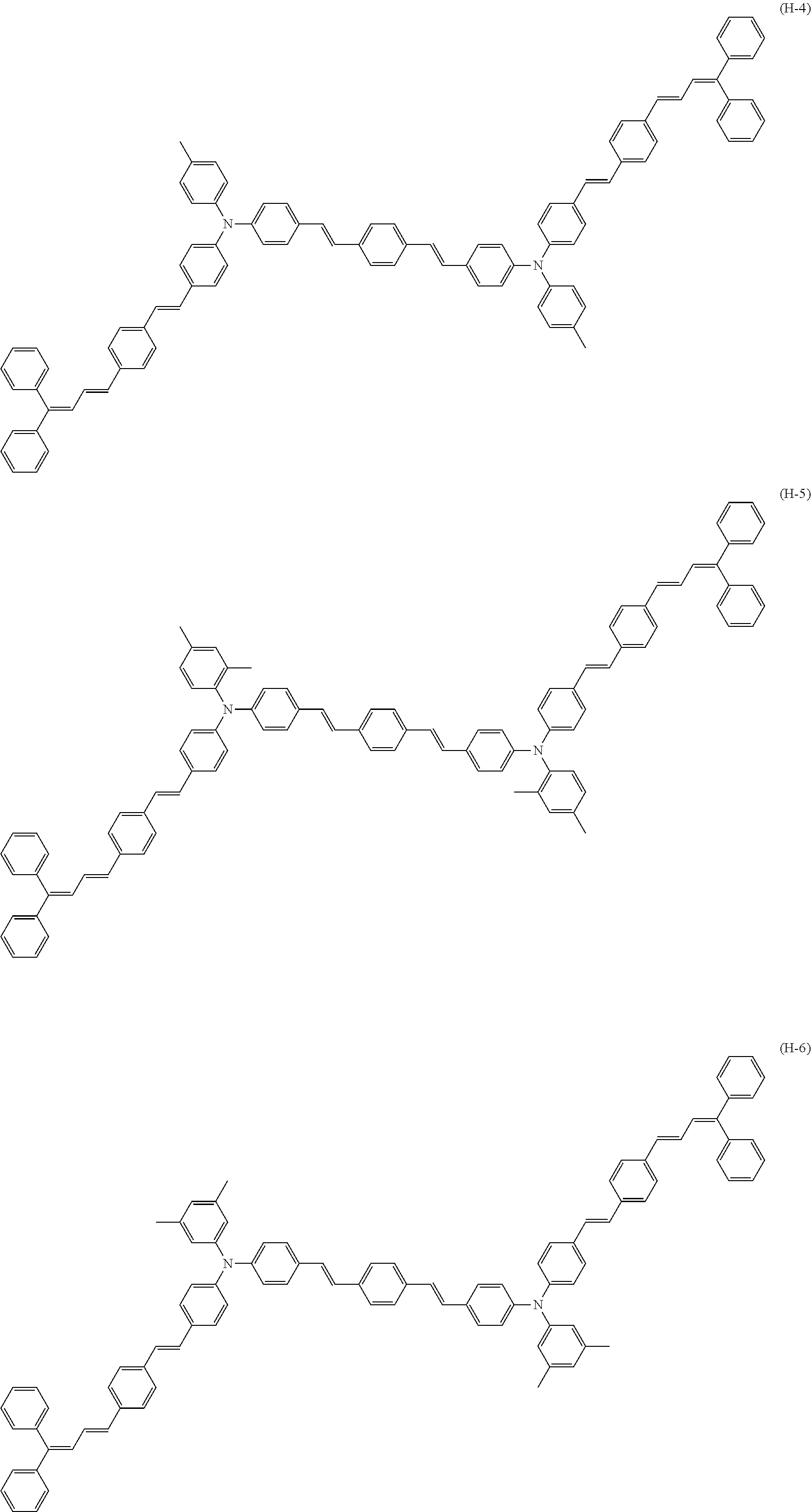

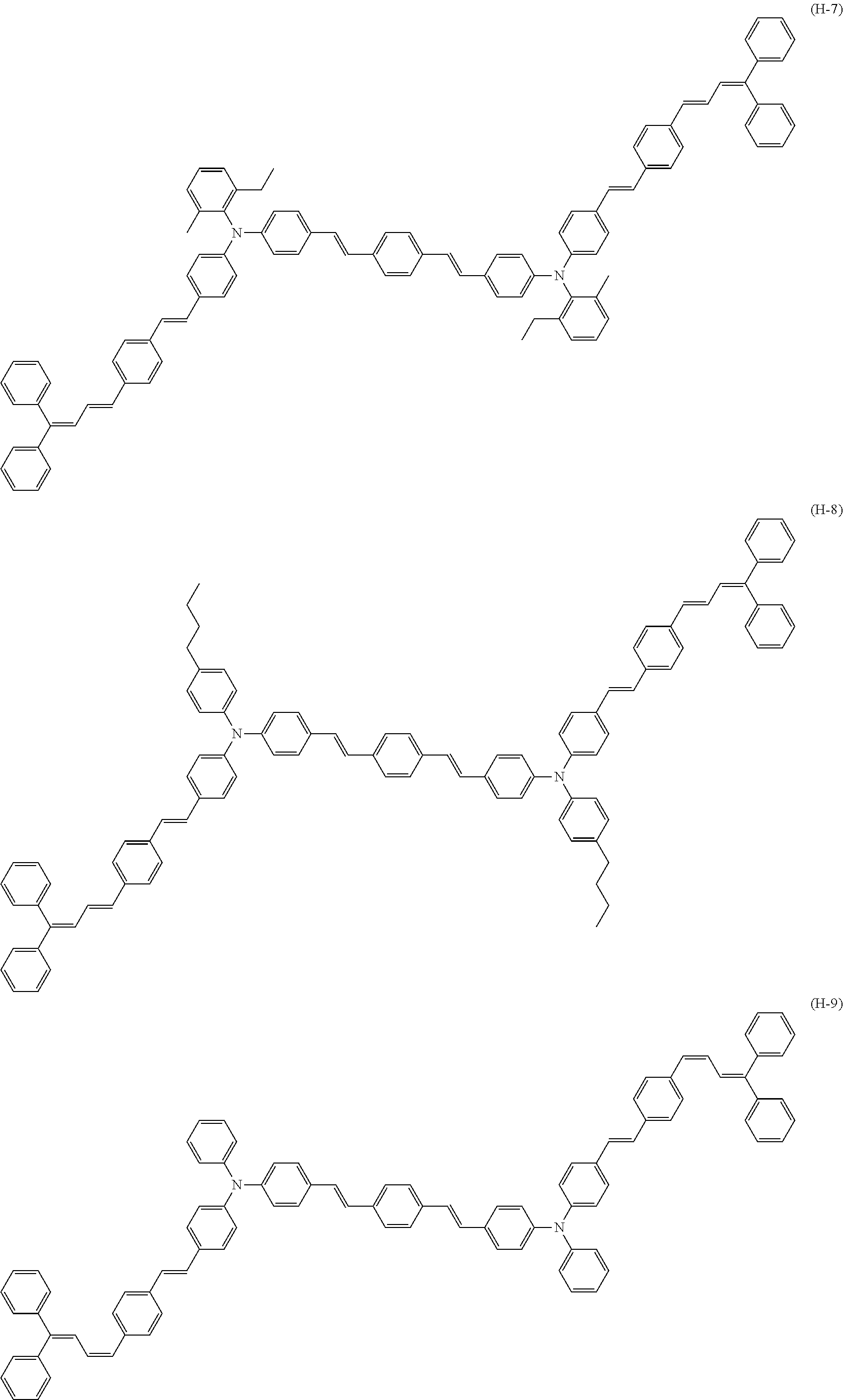

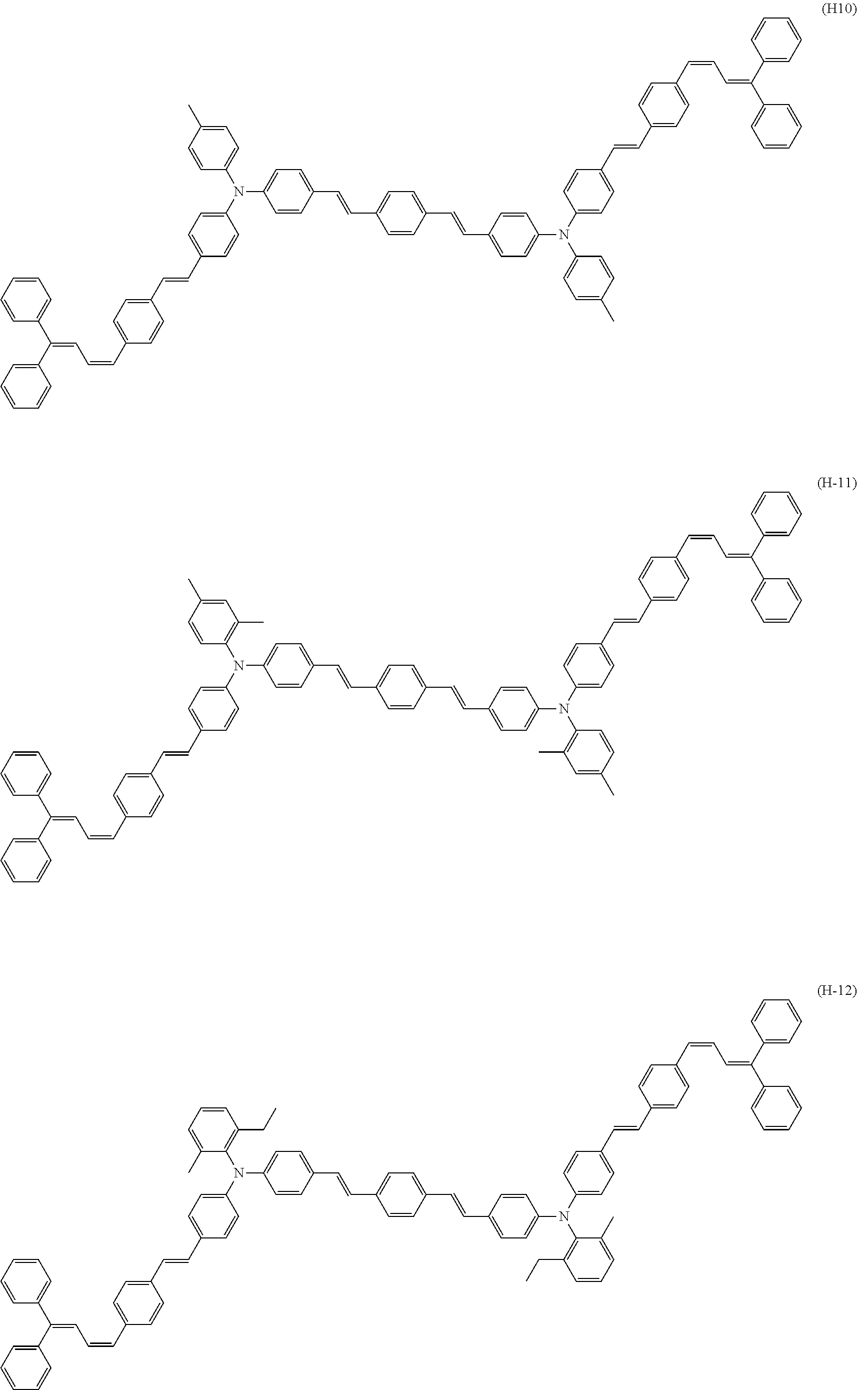

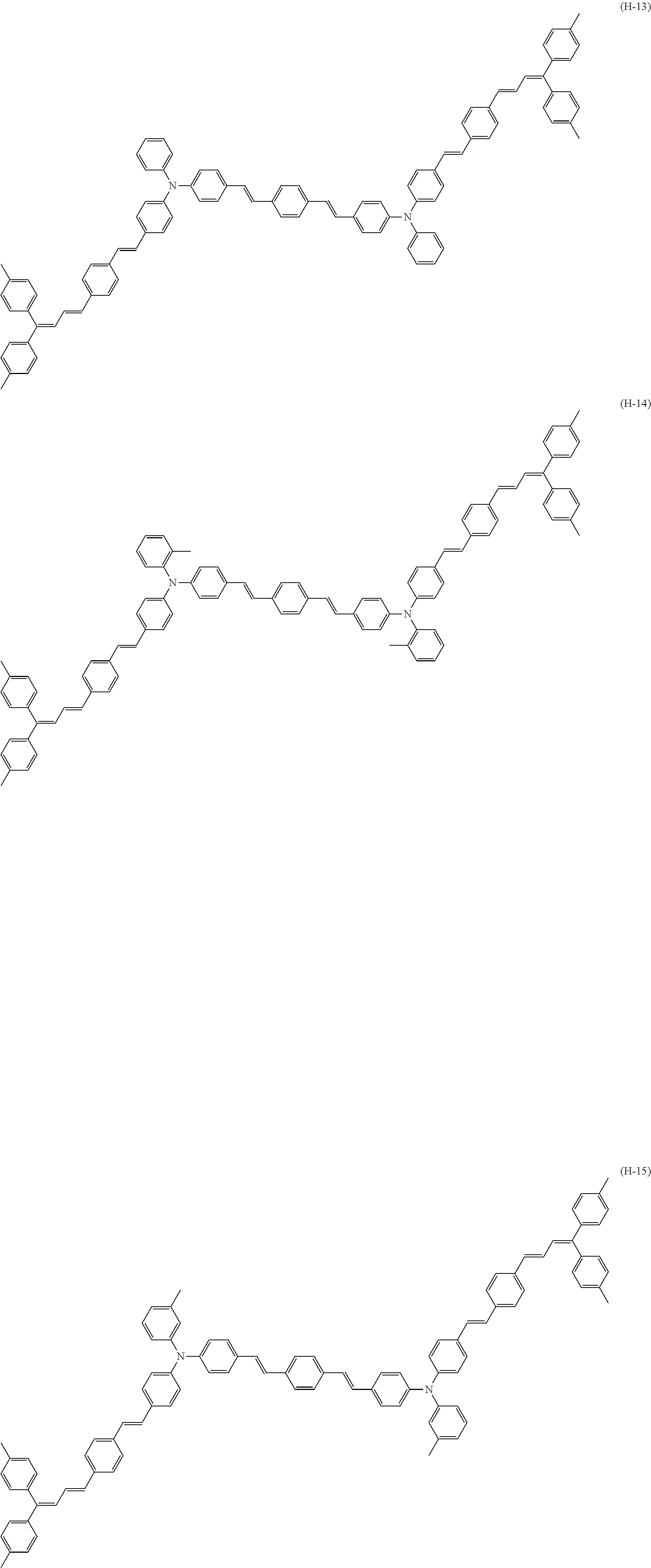

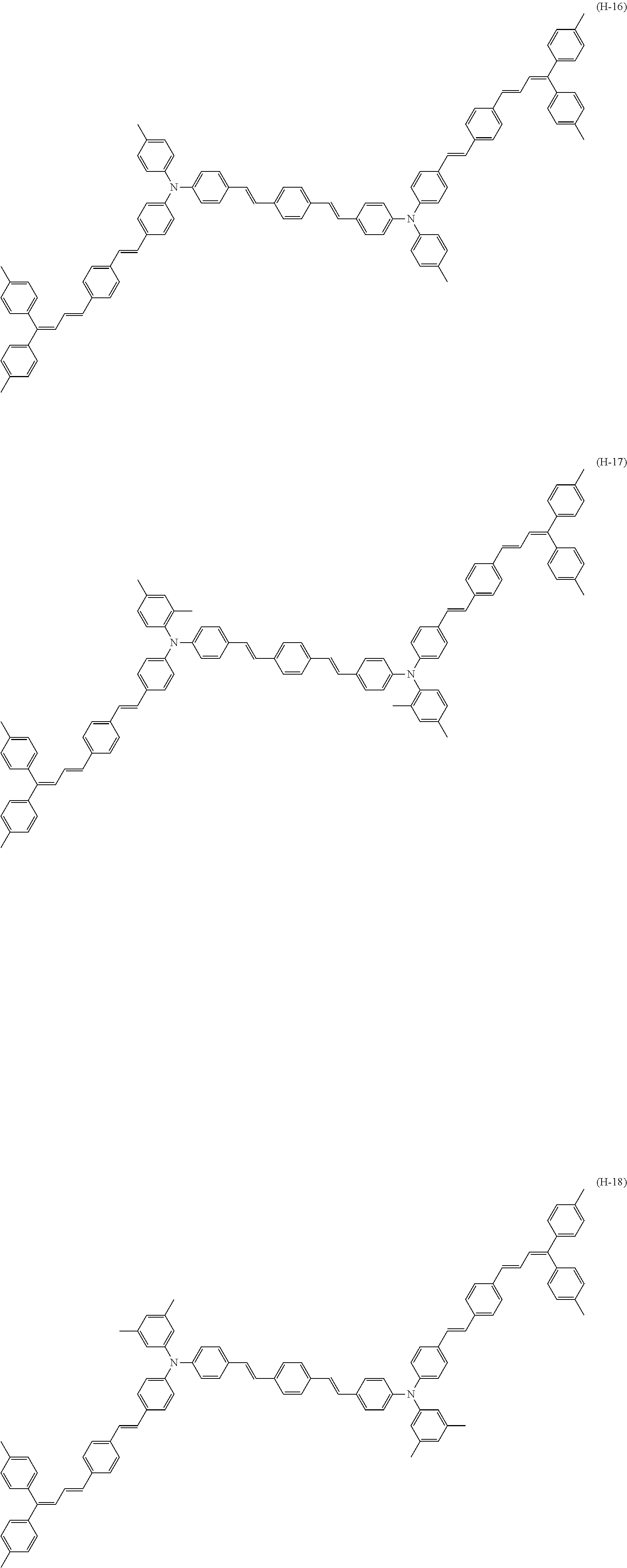

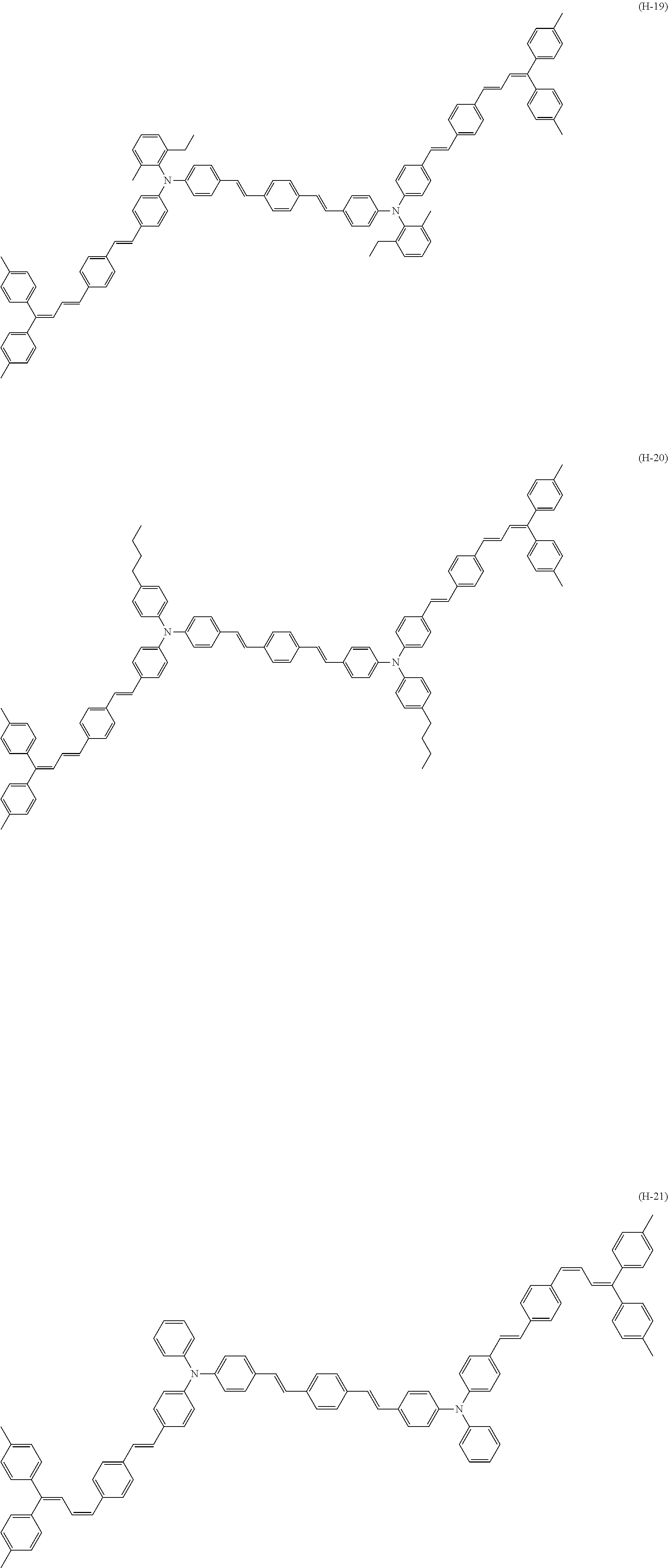

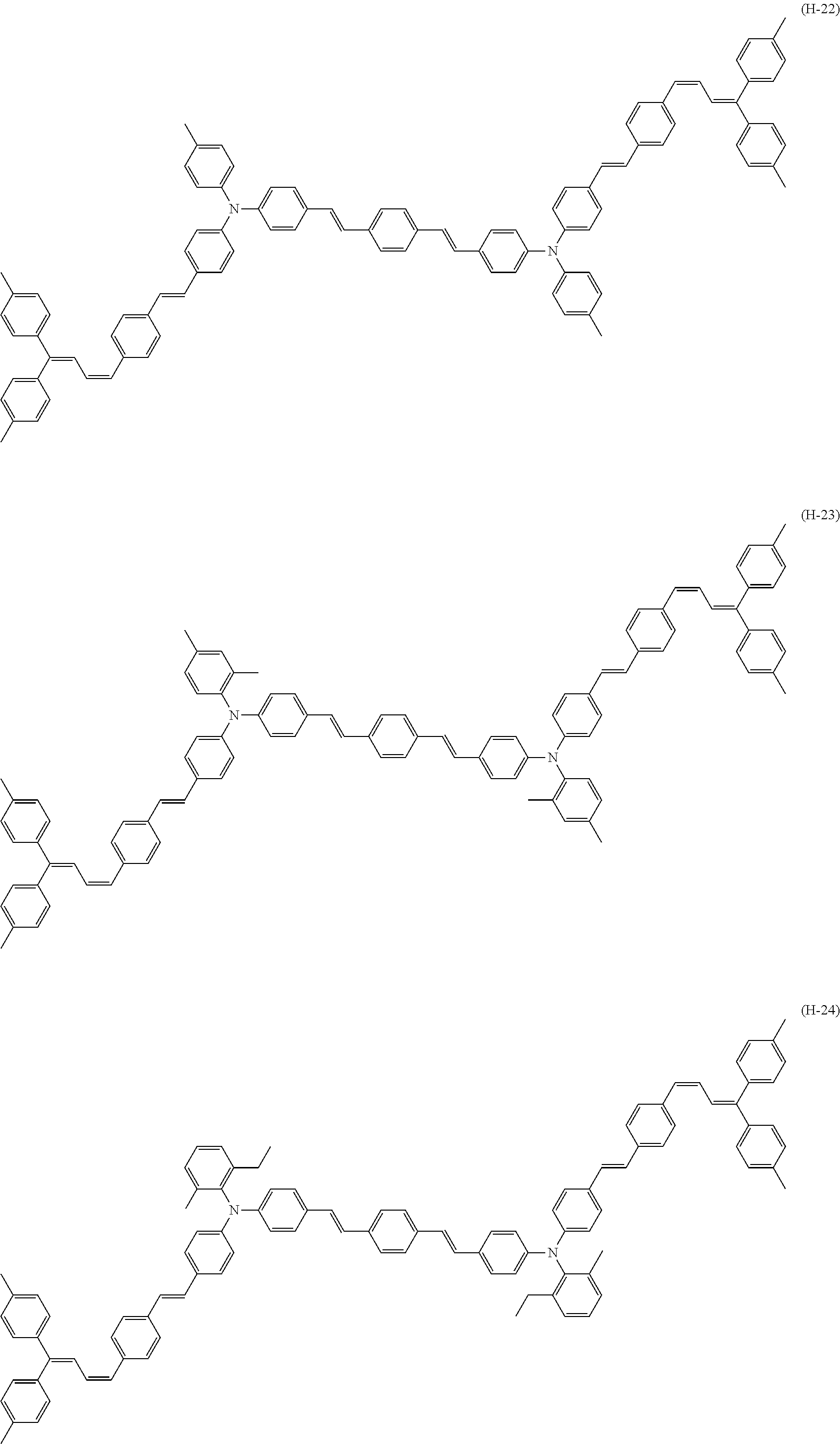

A compound having the structure represented by the general formula (2) can be produced, for example, by the method described in WO2017/138566.

In the charge transport layer 4, if necessary, another known hole transport material can be used in combination within a range that does not significantly impair an effect of the present invention.

Examples of the other known hole transport material include a hydrazone compound, a pyrazoline compound, a pyrazolone compound, an oxadiazole compound, an oxazole compound, an arylamine compound, a benzidine compound, a stilbene compound, a styryl compound, an enamine compound, a butadiene compound, a polyvinylcarbazole, and a polysilane, which can be used singly or in an appropriate combination of two or more thereof.

In the charge transport layer 4, the mass ratio H/(B+H) indicating the ratio of the mass (H) of a hole transport material to a sum of the mass (H) of the hole transport material and the mass (B) of a binder resin preferably satisfies the following formula (3):

20% by mass≤H/(B+H)≤50% by mass (3).

As a result, high solvent resistance can be realized while maintaining appropriate sensitivity characteristics. This is because excellent sensitivity characteristics can be obtained even when a relatively small amount of a hole transport material that satisfies the above-described formula (3) is used since the charge mobility of the hole transport material represented by the general formula (2) is large. Since the amount of the hole transport material can be reduced, the amount of the hole transport material eluted into the hydrocarbon solvent used as the liquid developer can be suppressed, and as a result, an electrophotographic photoreceptor having excellent solvent resistance and crack resistance can be provided.

Further, for the purpose of efficiently transporting electrons accumulated in the charge transport layer 4 to lower the residual potential and improve the sensitivity characteristics, the charge transport layer 4 can also contain an electron transport material within a range that does not significantly impair an effect of the present invention.

Specific examples of the electron transport material that can be used for the charge transport layer 4 include compounds having structures represented by the following formulas (E-1) to (E-6) but are not limited thereto.

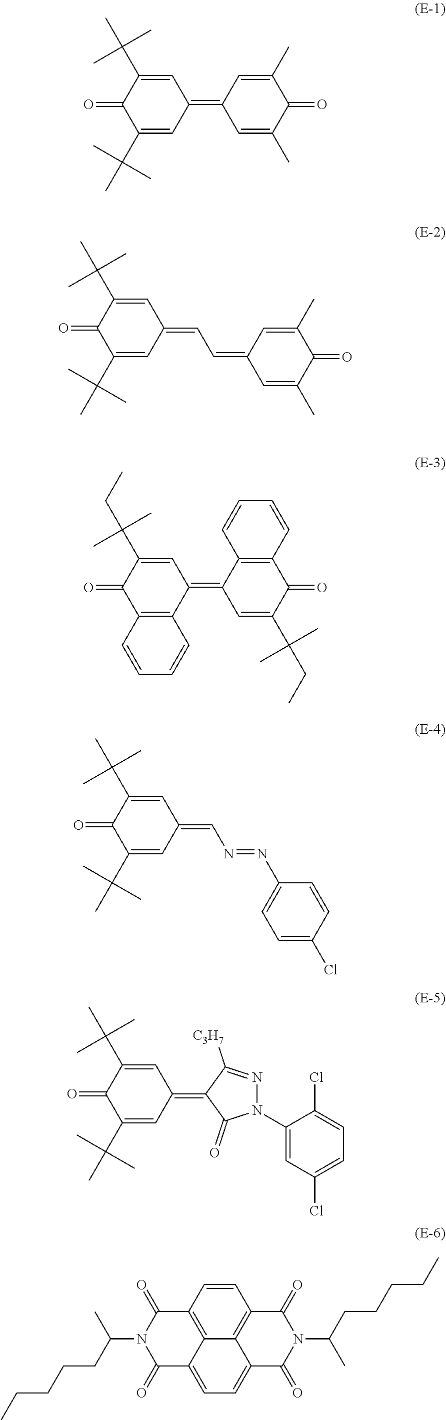

Conventionally known electron transport material can also be used in combination. Examples of such an electron transport material (acceptor compound) include succinic anhydride, maleic anhydride, dibromo succinic anhydride, phthalic anhydride, 3-nitrophthalic anhydride, 4-nitrophthalic anhydride, pyromellitic anhydride, pyromellitic acid, trimellitic acid, trimellitic anhydride, phthalimide, 4-nitrophthalimide, tetracyanoethylene, tetracyanoquinodimethane, chloranil, bromanyl, o-nitrobenzoic acid, malononitrile, trinitrofluorenone, trinitrothioxanthone, dinitrobenzene, dinitroanthracene, dinitroacridine, nitroanthraquinone, dinitroanthraquinone, a thiopyran compound, a quinone compound, a benzoquinone compound, a diphenoquinone compound, a naphthoquinone compound, an azoquinone compound, an anthraquinone compound, a diiminoquinone compound, and a stilbenequinone compound, which can be used singly or in an appropriate combination of two or more kinds thereof.

The charge transport layer 4 may further contain a conventionally known deterioration inhibitor such as an antioxidant, a radical scavenger, a singlet quencher, and an ultraviolet absorber for the purpose of improving weather resistance and stability against harmful light as long as an effect of the present invention is not significantly impaired.

Examples of such a compound include a chromanol derivative such as tocopherol, and an esterified compound, a polyarylalkane compound, a hydroquinone derivative, an etherified compound, a dietherified compound, a benzophenone derivative, a benzotriazole derivative, a thioether compound, a phenylenediamine derivative, a phosphonate ester, a phosphite ester, a phenol compound, a hindered phenol compound, a linear amine compound, a cyclic amine compound, a hindered amine compound, and a biphenyl derivative.

Further, the charge transport layer 4 may contain a leveling agent such as silicone oil or fluorine-based oil for the purpose of improving the leveling property of a formed film and imparting lubricity.

Furthermore, the charge transport layer 4 may contain a metal oxide such as silicon oxide (silica), titanium oxide, zinc oxide, calcium oxide, aluminum oxide (alumina), or zirconium oxide, a metal sulfate such as barium sulfate or calcium sulfate, fine particles of a metal nitride such as silicon nitride or aluminum nitride, or fluorine resin particles such as a tetrafluoroethylene resin, a fluorine comb-type graft polymer resin, or the like for the purpose of reducing the friction coefficient, imparting lubricity, or the like.

The content of the binder resin in the charge transport layer 4 is preferably from 20 to 90% by mass, and more preferably from 30 to 80% by mass, based on the solid content of the charge transport layer 4. The content of the total amount of the hole transport material and an optional electron transport material in the charge transport layer 4 is preferably from 10 to 80% by mass, and more preferably from 20 to 70% by mass, based on the solid content of the charge transport layer 4.

The thickness of the charge transport layer 4 is preferably 25 μm or less, more preferably from 5 to 25 μm, and further preferably from 10 to 25 μm. The charge transport layer 4 having such a film thickness can achieve favorable coatability, uniform film thickness, and high resolution while maintaining a practically effective surface potential.

In the photoreceptor of an embodiment of the present invention, a hole transport material represented by the above-described general formula (2) is excellent in compatibility with a binder resin represented by the above-described general formula (1), has high charge mobility, and has high injection efficiency from the charge generation material, and thus has excellent durability and sensitivity characteristics even if the charge transport layer 4 is a thin film. An electrophotographic photoreceptor including the charge transport layer 4 is a highly sensitive photoreceptor in which the absolute value of an initial sensitivity V_{L} (−V) measured using an electrical characteristics test system for photoreceptors under the conditions of an initial charged potential of −1,000 V, a travel time from exposure to a potential measurement probe of 0.03 s, an exposure light wavelength of 650 nm, and an exposure of 1.0 μJ/cm⁶ is 80 or less. The absolute value of the initial sensitivity V_{L} is preferably 70 or less, and more preferably 60 or less.

Furthermore, according to the photoreceptor of the embodiment of the present invention, when the photoreceptor is immersed in a hydrocarbon solvent contained in a developer for liquid development at room temperature for 100 hours, the amount of the hole transport material eluted from the charge transport layer can be reduced to 5×10⁻⁸ g/cm³ or less. By limiting the amount of the hole transport material eluted under a predetermined condition, the solvent resistance can be accurately determined in a relatively short time (100 hours). Examples of the hydrocarbon solvent contained in a developer for liquid development include ISOPAR L (manufactured by Exxon Mobil Corporation), which is an isoparaffin hydrocarbon. The amount of the hole transport material eluted is preferably 4×10⁻⁸ g/cm³ or less.

The photoreceptor of the embodiment of the present invention is excellent in solvent resistance and crack resistance when used in electrophotographic device for liquid development and is also excellent in sensitivity characteristics, and thus is useful as an electrophotographic photoreceptor for liquid development and is particularly suitable as a negatively charged layered type electrophotographic photoreceptor for liquid development.

### Process for Producing Electrophotographic Photoreceptor

The production process of an embodiment of the present invention includes, in producing the above-described photoreceptor, a step of forming the above-described charge generation layer and charge transport layer using a dip coating method. By using a dip coating method, a photoreceptor having favorable appearance quality and stable electrical characteristics can be produced while low cost and high productivity are ensured. In producing a photoreceptor, there is no particular limitation except that a dip coating method is used, and such production can be carried out according to a conventional method. The production process may further include a step of preparing a conductive base and may include a step of dip-coating a charge generation layer and a charge transport layer on the conductive base sequentially.

Specifically, first, any charge generation material is dissolved and dispersed in a solvent together with any binder resin, or the like to prepare a coating liquid for forming a charge generation layer, and this coating liquid for charge generation layer is applied to the outer periphery of the conductive base through an intermediate layer if necessary, and dried to form a charge generation layer. Next, a coating liquid for forming a charge transport layer is prepared by dissolving the predetermined binder resin and the hole transport material and any electron transport material, additive, and the like in a solvent, and this coating liquid for the charge transport layer is coated on the charge generation layer and dried to form a charge generation layer, whereby a photoreceptor can be produced. Here, the type of solvent used for preparing the coating liquid, the coating conditions, the drying conditions, and the like can be appropriately selected according to a conventional method and are not particularly limited.

### Electrophotographic Device

The electrophotographic device according to an embodiment of the present invention include: the photoreceptor described above; a charging device for charging the photoreceptor; an exposure apparatus for exposing the charged photoreceptor to form an electrostatic latent image on the surface thereof; a development device for forming a toner image by developing an electrostatic latent image formed on the surface of a photoreceptor using a liquid developer in which a toner is dispersed in a hydrocarbon solvent; and a transfer device for transferring the toner image formed on the surface of a photoreceptor to a recording medium. Even when immersed in a hydrocarbon solvent used as a liquid developer for a long time, by providing an electrophotographic photoreceptor with a small amount of hole transport material eluted, excellent solvent resistance and crack resistance, and excellent sensitivity characteristics, an electrophotographic device for liquid development having excellent durability can be provided. The electrophotographic device may further include a fixing device for fixing a toner image transferred to a recording medium.

FIG. 2 is a schematic configuration diagram showing an example of an electrophotographic device of the present invention. The illustrated electrophotographic device includes: a charging roller 12 serving as a charging device and an exposure light source 13 serving as an exposure apparatus, which are arranged on an outer peripheral portion of an electrophotographic photoreceptor 11; a liquid developer 14 including a developing roller 14a and a liquid developer 14b as a development device; a transfer device 15 as a transfer device; and a fixing roller 17 as a fixing device, and may be used as a color printer. In the drawing, the transfer material 16 may be a recording medium such as paper. Reference numeral 18 in the drawing denotes a cleaning blade, and 19 denotes a light source for static elimination.

### EXAMPLES

Hereinafter, the present invention will be described in detail by way of Examples. The present invention is not limited to the description of the Examples without departing from the gist thereof.

### Production of Negatively Charged Layered Type Electrophotographic Photoreceptor

### Example 1

Fifteen (15) parts by mass of a p-vinylphenol resin (trade name: Marukalinker MH-2, manufactured by Maruzen Petrochemical Co., Ltd.), 10 parts by mass of an N-butylated melamine resin (trade name: Uban 2021, manufactured by Mitsui Chemicals, Inc.), and 75 parts by mass of titanium oxide fine particles treated with aminosilane were dissolved or dispersed in a mixed solvent of 750 parts by mass/150 parts by mass of methanol/butanol to prepare a coating liquid for forming an intermediate layer. A conductive base made of an aluminum alloy with outer diameter of 30 mm and length of 255 mm was immersed in the obtained coating liquid for an intermediate layer, and then pulled up to form a coating film on the outer periphery. The base was dried at a temperature of 140° C. for 30 minutes to form an intermediate layer having a thickness of 3 μm.

Next, 15 parts by mass of Y-type titanyl phthalocyanine described in JPS64-17066A as a charge generation material and 15 parts by mass of polyvinyl butyral (trade name: S-LEC B BX-1, manufactured by Sekisui Chemical Co., Ltd.) as a binder resin were dispersed in 600 parts by mass of dichloromethane for 1 hour using a sand mill disperser to prepare a coating liquid for forming a charge generation layer. The coating liquid for a charge generation layer was applied onto the intermediate layer by dip coating and dried at a temperature of 80° C. for 30 minutes to form a 0.3 μm-thick charge generation layer.

Next, 130 parts by mass of a copolycarbonate resin, as a binder resin, having a viscosity-average molecular weight of 54,500 having a structure represented by the structural formula (B-3), where n/(m+n)=0.4 and the chain end group is represented by the following structural formula (4):

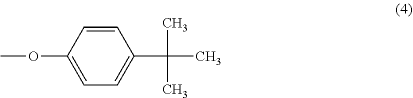

70 parts by mass of a compound, as a hole transport material, represented by the above-described structural formula (H-5) and 1 part by mass of a compound, as an electron transport material, represented by the above-described structural formula (E-5) were dissolved in 900 parts by mass of tetrahydrofuran, and 3 parts by mass of a silicone oil (trade name: KP-340, manufactured by Shin-Etsu Polymer Co., Ltd.) was added thereto to prepare a coating liquid for forming a charge transport layer. The coating liquid for a charge transport layer was applied onto the charge generation layer by dip coating and dried at a temperature of 130° C. for 60 minutes to form a charge transport layer having a thickness of 20 μm. A negatively charged layered type electrophotographic photoreceptor was prepared by the process described above.

In the charge transport layer, the mass ratio H/(B+H) indicating the ratio of the mass (H) of a hole transport material to a sum of the mass (B) of a binder resin and the mass (H) of the hole transport material was 35% by mass.

### Examples 2 to 4, 6, 7, Comparative Examples 1 to 4

A negatively charged layered type electrophotographic photoreceptor was produced in the same manner as in Example 1, except that the types and blending amounts of binder resins and hole transport materials in the charge transport layer were changed as shown in Table 1 below.

The materials used are shown below.

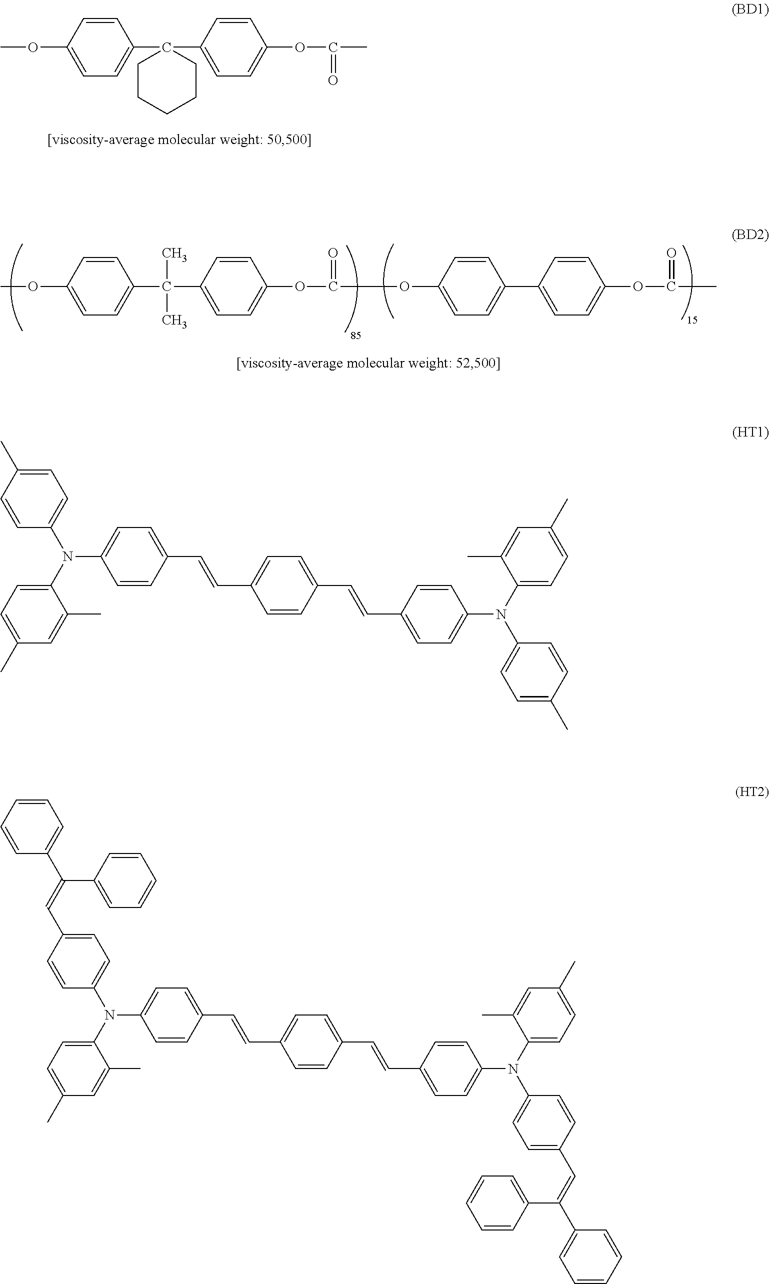

### Example 5

A negatively charged layered type electrophotographic photoreceptor was produced in the same manner as in Example 1, except that the binder resin of the charge transport layer was changed to a copolycarbonate resin having a viscosity-average molecular weight of 49,500 having a structure represented by the structural formula (B-1), where n/(m+n)=0.6 and the chain end group is represented by the following structural formula (4):

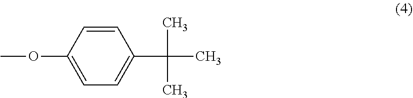

TABLE 1

| | Binder resin | | Hole transport material | | Mass ratio |
|---|---|---|---|---|---|
| | | Compounding | | Compounding | H(B + H) |
| | | amount | | amount | (% by |
| | Type | (parts by mass) | Type | (parts by mass) | mass) |
| Example 1 | B-3 | 130 | H-5 | 70 | 35 |
| Example 2 | B-3 | 160 | H-5 | 40 | 20 |
| Example 3 | B-3 | 100 | H-5 | 100 | 50 |
| Example 4 | B-3 | 130 | H-17 | 70 | 35 |
| Examples 5 | B-1 | 130 | H-5 | 70 | 35 |
| Comparative | BD1 | 130 | H-5 | 70 | 35 |
| Example 1 | | | | | |
| Comparative | BD2 | 130 | H-5 | 70 | 35 |
| Example 2 | | | | | |
| Comparative | B-3 | 130 | HT1 | 70 | 35 |
| Example 3 | | | | | |
| Comparative | B-3 | 130 | HT2 | 70 | 35 |
| Example 4 | | | | | |
| Example 6 | B-3 | 170 | H-5 | 30 | 15 |
| Example 7 | B-3 | 90 | H-5 | 110 | 55 |

Using photoreceptors produced in Examples 1 to 7 and Comparative Examples 1 to 4, the sensitivity characteristics and the solvent resistance (the amount of the hole transport material eluted and the presence or absence of a crack) were evaluated by the following evaluation methods.

### Sensitivity Characteristics Evaluation

The sensitivity characteristics of the obtained photoreceptors were evaluated using an electrical characteristics tester (CYNTHIA, manufactured by GENTEC CO., LTD.) under the following conditions under the environment of a temperature of 23° C. and a relative humidity of 50%.

First, an angle and a rotation speed of a photoreceptor were set in such a manner that travel time from exposure to a potential measurement probe was 0.03 s; the surface of the photoreceptor was charged to an initial charged potential of −1,000 V by corona charging in a dark place; monochromatic light having a wavelength of 650 nm, which was obtained by using a halogen lamp as a light source and spectrally separated using a band-pass filter, was then irradiated on the surface of the photoreceptor at an exposure of 1.0 μJ/cm²; and the surface potential of the photoreceptor at this time was measured to obtain the initial sensitivity V_{L}(−V).

After the measurement of the initial sensitivity, the photoreceptor was immersed in a hydrocarbon solvent (ISOPAR L, manufactured by Exxon Mobil Corporation) used as a developer for liquid development at room temperature (25° C.) for 100 hours, and after removal of the photoreceptor, the ISOPAR L attached to the surface of the photoreceptor was removed, whereby the sensitivity was measured in the same manner. The sensitivity change amount ΔV(V) between the initial sensitivity and the sensitivity after immersion in the ISOPER was then calculated.

### Evaluation of Elution Amount of Hole Transport Material

The obtained photoreceptor was immersed for 100 hours in a room temperature environment (25° C.) in 250 ml of a hydrocarbon solvent (Isopar L, manufactured by Exxon Mobil Corporation) in such a manner that 10 cm from the lower end was immersed. Next, the absorbance in the ultraviolet region to the visible region of the hydrocarbon solvent in which the photoreceptor was immersed was measured using an ultraviolet-visible-near-infrared spectrophotometer (UV-3100, manufactured by Shimadzu Corporation).

For a plurality of solutions in which a hole transport material is dissolved in a hydrocarbon solvent having different hole transport material concentrations, similarly, the absorbance at the absorption peak wavelength in the ultraviolet region to the visible region was measured, and a calibration curve was prepared in advance from the relationship between the concentration of a hole transport material and the absorbance of a prepared solution. By using this calibration curve, the amount of the hole transport material eluted in the hydrocarbon solvent in which the photoreceptor was immersed was calculated.

### Crack Evaluation

The appearance of the photoreceptor after the evaluation of the amount of the hole transport material eluted was visually observed, and the presence or absence of a crack was evaluated according to the following criteria:

○: No cracks occurred;

Δ: Some small cracks occurred; and

x: Cracks occurred over a wide area.

The results obtained are shown in Table 2 below.

TABLE 2

| | | Solvent resistance | | |
|---|---|---|---|---|
| | Initial | Sensitivity | Elution amount | |
| | sensitivity | change | (100 hours) | Crack |
| | V_{L} (−V) | amount ΔV(V) | (10⁻⁸ g/cm³) | evaluation |
| Example 1 | 43 | +2 | 1.2 | ◯ |
| Example 2 | 70 | +1 | 1.0 | ◯ |
| Example 3 | 34 | +4 | 3.8 | ◯ |
| Example 4 | 39 | +2 | 1.5 | ◯ |
| Example 5 | 41 | +3 | 2.4 | ◯ |
| Comparative | 44 | +28 | 7.3 | Δ |
| Example 1 | | | | |
| Comparative | 40 | +24 | 6.8 | Δ |
| Example 2 | | | | |
| Comparative | 79 | +35 | 231.9 | × |
| Example 3 | | | | |
| Comparative | 69 | +6 | 97.5 | × |
| Example 4 | | | | |
| Example 6 | 86 | +1 | 0.9 | ◯ |
| Example 7 | 33 | +11 | 5.4 | Δ |

From the above-described results, it was confirmed that each photoreceptor of each embodiment using a specific binder resin and a hole transport material in combination was excellent in sensitivity characteristics measured under predetermined conditions and was also excellent in solvent resistance and crack resistance to hydrocarbon solvents used as developers for liquid development.

In contrast, in the cases of Comparative Examples 1 and 2 using binder resins BD1 and BD2 other than the binder resin represented by the above-described general formula (1) and Comparative Examples 3 and 4 using hole transport materials HT1 and HT2 other than the hole transport material represented by the above-described general formula (2), the amount of the hole transport material eluted when immersed in the hydrocarbon solvent used for the developer for liquid development was large. In addition, in Comparative Examples 1 to 4, not only the change between the initial sensitivity and the sensitivity after immersion in the hydrocarbon solvent was large, but cracks were seen on the photoreceptor surface after immersion in a hydrocarbon solvent, indicating that the solvent resistance with respect to the hydrocarbon solvent was insufficient. The increase in the sensitivity and the occurrence of cracks due to solvent immersion are considered to be due to the elution of the hole transport material.

In Example 6 in which the mass ratio H/(B+H) between the binder resin and the hole transport material was less than 20% by mass, although the elution amount was small and the solvent resistance to the hydrocarbon solvent was sufficient, the sensitivity characteristics were slightly deteriorated. The deterioration in sensitivity indicates that the charge transport layer has insufficient transport ability. Further, in Example 7 in which the mass ratio H/(B+H) of the binder resin to the hole transport material exceeds 50% by mass, although the sensitivity characteristics were excellent, the amount of the hole transport material eluted into the hydrocarbon solvent slightly increased, and a minute crack was partially observed in the photoreceptor, and the solvent resistance was slightly deteriorated.

### DESCRIPTION OF SYMBOLS

1 Conductive base;
2 Intermediate layer;
3 Charge generation layer;
4 Charge transport layer;
11 Electrophotographic photoreceptor;
12 Charging roller;
13 Exposure light source;
14 Liquid developer;
14a Developing roller;
14b Liquid developer;
15 Transfer device;
16 Transfer material;
17 Fixing roller;
18 Cleaning blade; and
19 Light source for static elimination.

1. An electrophotographic photoreceptor, comprising:
a conductive base; and
a charge generation layer and a charge transport layer sequentially provided on the conductive base,
wherein the charge transport layer contains a binder resin that is a copolycarbonate resin having a structure represented by general formula (1) below: 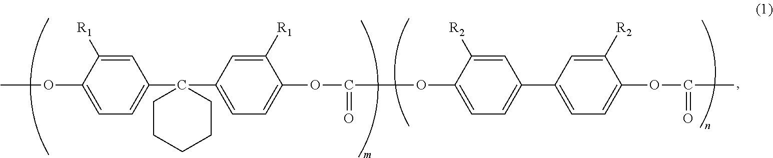
where R₁ and R₂ are the same or different and each represents a hydrogen atom, an alkyl group having from 1 to 10 carbon atoms or a fluoroalkyl group having from 1 to 10 carbon atoms, m and n are numbers satisfying 0.4≤n/(m+n)≤0.6, and a chain end group that is a monovalent aromatic group; and
a hole transport material that is a compound having a structure represented by general formula (2) below: 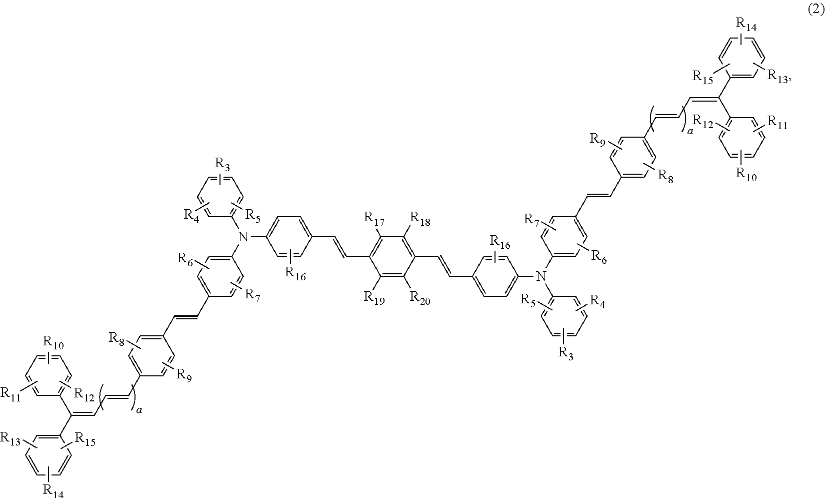
where R₃ to R₂₀ are the same or different and each represents a hydrogen atom, an alkyl group having from 1 to 6 carbon atoms, an alkoxy group having from 1 to 6 carbon atoms, an aryl group, or an aryl-substituted alkenyl group, and a represents an integer from 0 to 2.

2. The electrophotographic photoreceptor according to claim 1, wherein a mass ratio H/(B+H) indicating a ratio of mass (H) of the hole transport material to a sum of the mass (H) of the hole transport material and a mass (B) of the binder resin in the charge transport layer satisfies formula (3) below:
20% by mass≤H/(B+H)≤50% by mass (3).

3. The electrophotographic photoreceptor according to claim 1, wherein the charge transport layer has a thickness of 25 μm or less.

4. The electrophotographic photoreceptor according to claim 1, wherein the charge generation layer contains a charge generation material that is Y-type titanyl phthalocyanine.

5. The electrophotographic photoreceptor according to claim 1, wherein the electrophotographic photoreceptor has an initial sensitivity V_{L} (−V) that has an absolute value measured using an electrical characteristics test system for photoreceptors under conditions including an initial charged potential of −1,000 V, a travel time from exposure to a potential measurement probe of 0.03 s, an exposure light wavelength of 650 nm, and an exposure of 1.0 μJ/cm² that is 80 or less.

6. The electrophotographic photoreceptor according to claim 1, wherein the hole transport material is eluted from the charge transport layer, when the electrophotographic photoreceptor is immersed in a hydrocarbon solvent contained in a developer for liquid development at room temperature for 100 hours, in an eluted amount that is 5×10⁻⁸ g/cm³ or less.

7. A process for producing the electrophotographic photoreceptor according to claim 1, the process comprising:
forming the charge generation layer and the charge transport layer by using a dip coating method.

8. An electrophotographic device, comprising:
the electrophotographic photoreceptor according to claim 1;
a charging device for charging the electrophotographic photoreceptor to provide a charged electrophotographic photoreceptor;
an exposure apparatus for exposing the charged electrophotographic photoreceptor to form an electrostatic latent image on a surface thereof;
a development device for forming a toner image by developing the electrostatic latent image formed on the surface of the electrophotographic photoreceptor using a liquid developer in which a toner is dispersed in a hydrocarbon solvent; and
a transfer device for transferring the toner image formed on the surface of the electrophotographic photoreceptor to a recording medium.
